(19) United States
(12) Patent Application Publication
(10) Pub. No.: US 2017/0306609 A1
(43) Pub. Date: Oct. 26, 2017

(54) CRANE BUILDING

(71) Applicant: FOLDING HOLDINGS LLC, Woodinville, WA (US)

(72) Inventor: Elliot Peterson, Woodinville, WA (US)

(21) Appl. No.: 15/494,959

(22) Filed: Apr. 24, 2017

Related U.S. Application Data
(60) Provisional application No. 62/327,788, filed on Apr. 26, 2016.

(51) Int. Cl. E04B 1/19; E04B 7/20; B66C 17/06; E04B 1/24; E04H 5/02; E04C 3/32

(52) U.S. Cl. CPC E04B 1/19; E04B 1/24; E04B 7/20; E04H 5/02; B66C 17/06; E04B 2001/1978; E04B 2103/06; E04C 3/32; E04B 2001/199

(57) ABSTRACT

A series of moment frames, each including two opposing spaced apart vertical legs and a horizontal crossbar connecting the top ends of the legs, are arranged linearly in spaced apart side-by-side array and opposing outer horizontal panel support beams are connected to the outside faces of the legs on each building side, offset below the crossbars. On the inside faces of the legs and running parallel to the beams, first and second opposing crane rails are attached. A bridge crane is mounted on the crane rails. Four-panel folding sections are assembled in an adjacent side-by-side array and rest on the panel support beams. Individual wall panels, arranged side-by-side, enclose the space from the bottoms of the legs (ground level) to the panel support beams. End panels, in various configurations, close the ends of the crane building and allow access doors or and other openings.

### RELATED APPLICATIONS

This application claims the benefit of U.S. provisional patent application 62/327,788 filed Apr. 26, 2016 to the same inventor.

### TECHNICAL FIELD

This invention relates to providing a building for supporting, enclosing, and operating a bridge crane. This invention more particularly relates to a folding building made of foldable prefabricated transverse four-panel hinged sections in which two panels are roof panels and two panels are wall panels. The sections are unfolded and placed end-to-end, supported on opposed horizontal beams that are connected to legs of moment frames, to form a building of any desired length. Unique end sections and end panels are used to close the ends of the building.

### OBJECTS AND FEATURES OF THE INVENTION

An object and feature of the present invention is to provide a prefabricated steel crane building that can be easily erected.

Another object and feature of the present invention is to provide a crane building that uses a linear array of moment frames as building structure.

Another object and feature of the present invention is to provide a crane building that has high headroom above the crane.

It is a further object and feature of the present invention to provide a sequence of building steps that simplifies construction of the crane building.

It is a further object and feature of the present invention to provide a crane building that is easily relocatable.

It is a further object and feature of the present invention to provide various configurations of a crane building.

It is an additional primary object and feature of the present invention to provide such crane buildings that are efficient, inexpensive and handy. Other objects and features of this invention will become apparent with reference to the following descriptions.

### SUMMARY OF THE INVENTION

A series of moment frames, each including two opposing spaced apart vertical legs and a horizontal crossbar connecting the top ends of the legs, are arranged linearly in spaced apart side-by-side array and opposing outer horizontal panel support beams are connected to the outside faces of the legs on each building side, offset below the crossbars. On the inside faces of the legs and running parallel to the beams, first and second opposing crane rails are attached. A bridge crane is mounted on the crane rails. Four-panel folding sections, similar to those described in U.S. Pat. No. 9,222,250 to at least one common inventor, are assembled in an adjacent side-by-side array and rest on the panel support beams. The four-panel folding sections differ from those in U.S. Pat. No. 9,222,250 in that the wall sections are shorter and the bottoms of the walls have flanges adapted for attaching to the beams, rather than to a concrete slab. Individual wall panels, arranged side-by-side and similar to the wall panels in U.S. Pat. No. 9,222,250, enclose the space from the bottoms of the legs (ground level) to the panel support beams. The individual wall panels differ from the foldable section wall panels in U.S. Pat. No. 9,222,250 in that the top edges are adapted for attachment to the panel support beams. End panels, in various configurations, close the ends of the crane building and allow access doors or and other openings.

### BRIEF DESCRIPTION OF THE DRAWINGS

The present invention will hereinafter be described in conjunction with the following drawing figures, wherein like numerals denote like elements, and

FIG. 1 is a top-front perspective view illustrating a first exemplary embodiment of a crane building in a first phase of construction, according to a preferred embodiment of the present invention;

FIG. 2 is a top-front perspective view illustrating a first exemplary embodiment of a crane building of FIG. 1 in a second phase of construction, according to a preferred embodiment of the present invention;

FIG. 3 is a top-front perspective view illustrating a first exemplary embodiment of a crane building of FIG. 1 in a third phase of construction, according to a preferred embodiment of the present invention;

FIG. 4 is a top-front perspective view illustrating a first exemplary embodiment of a crane building of FIG. 1 in a fourth phase of construction, according to a preferred embodiment of the present invention; and

FIG. 5 is a top-front perspective view illustrating a first exemplary embodiment of a crane building of FIG. 1 in an optional fifth phase of construction, according to a preferred embodiment of the present invention.

### DETAILED DESCRIPTION OF THE PRESENT INVENTION

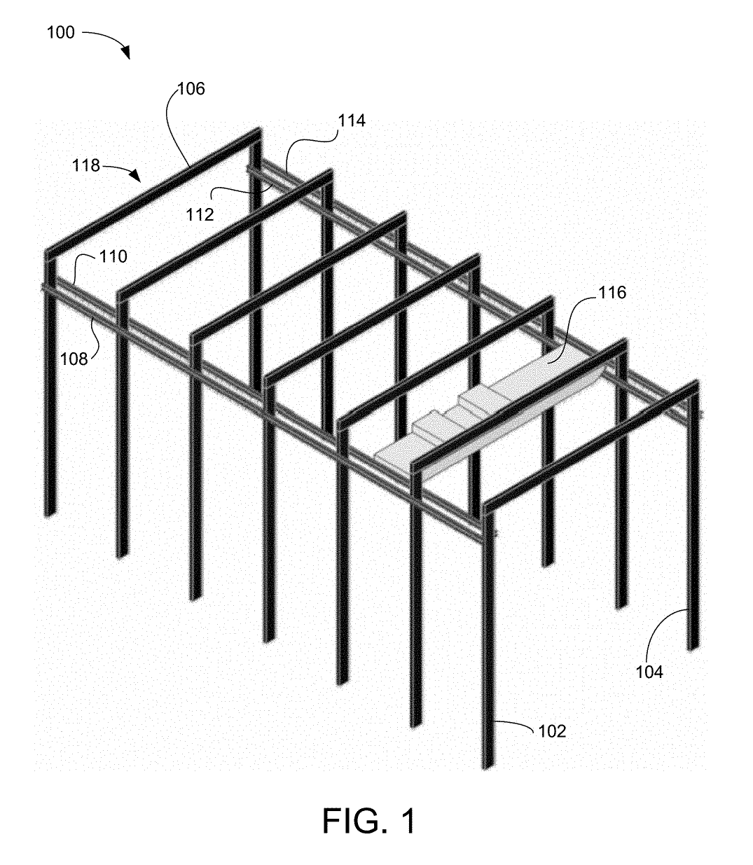

FIG. 1 is a top-front perspective view illustrating a first exemplary embodiment of a crane building 100 in a first phase of construction, according to a preferred embodiment of the present invention. Seven moment frames 118 (one of seven labeled), each including two opposing spaced apart vertical legs 102 (one of seven labeled) and 104 (one of seven labeled) and a horizontal crossbar 106 (one of seven labeled) connected at the top ends of the legs 102 and 104, are arranged linearly in spaced apart array and have opposing outer horizontal panel support beams 108 and 114 that are connected to the outside faces of the legs 102 and 104, positioned spaced apart below the crossbars 106. Legs 102 and 104 of moment frames 118 preferably rest on, and are secured to, a concrete slab at ground level but may, in particular embodiments, rest on, and be secured to, individual pads or similarly stable supports. In various embodiments, more or fewer than seven moment frames 118 may be used. For example, in a railroad depot warehousing embodiment, the crane building 100 may have enough sections to extend for a mile or more. Connections between and attachments to crane building 100 parts 102, 104, 106, 108, 110, 112, and 114 and to the concrete slab are preferably made via releasable fasteners and more preferably by using bolts. The use of releasable fasteners enables the crane building 100 to be easily disassembled and relocated to a new job site.

On the inside faces of the legs 102 and 104 and preferably running parallel and coplanar with the panel support beams 108 and 114, first and second opposing crane rails 110 and 112 are attached. A bridge crane 116 is mounted on the crane rails 110 and 112. Moment frames 118, panel support beams 108 and 114, and crane rails 110 and 112 are preferably made of steel members of the commercially available sort. The headroom over the crane 116 is customized by changing one or both of: the distance between the crane rails 110 and 112 and the crossbars 106, and the pitch of the roof. Headroom above the bridge crane 116 is desirable for ease of maintenance.

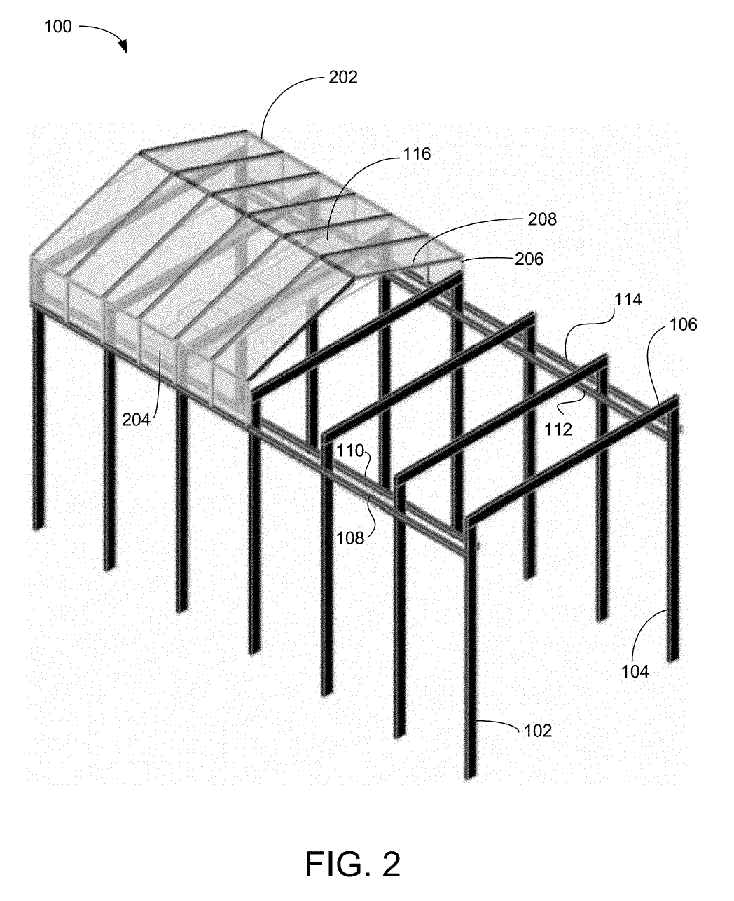

FIG. 2 is a top-front perspective view illustrating a first exemplary embodiment of a crane building 100 of FIG. 1 in a second phase of construction, according to a preferred embodiment of the present invention. Four-panel folding sections 202 (one of six labeled), similar to those described in U.S. Pat. No. 9,222,250 to one common inventor (incorporated herein by reference), are assembled side-by-side and are supported on, and attached to, the panel support beams 108 and 114. The four-panel folding sections 202 differ from those in U.S. Pat. No. 9,222,250 in that the wall panels 204 (one of six labeled) are shorter and the bottoms of the wall panels 204 have flanges adapted for attaching to the panel support beams 108 and 114 via releasable fasteners, rather than to a concrete slab. In various embodiments, the wall panels 204 may be higher or shorter, as the various applications require. The method of unfolding the four-panel sections and lifting them into place is generally as described in U.S. Pat. No. 9,222,250. The opposing wall panels 204 in each four-panel folding section 202 have opposing columns 206 and the roof panels 210 (one of twelve labeled) have opposing rafters 208. Columns 206 of adjacent four-panel folding sections 202 are fastened together, preferably using releasable fasteners, during installation and rafters 208 of adjacent four-panel folding sections 202 are fastened together, preferably using releasable fasteners, during installation.

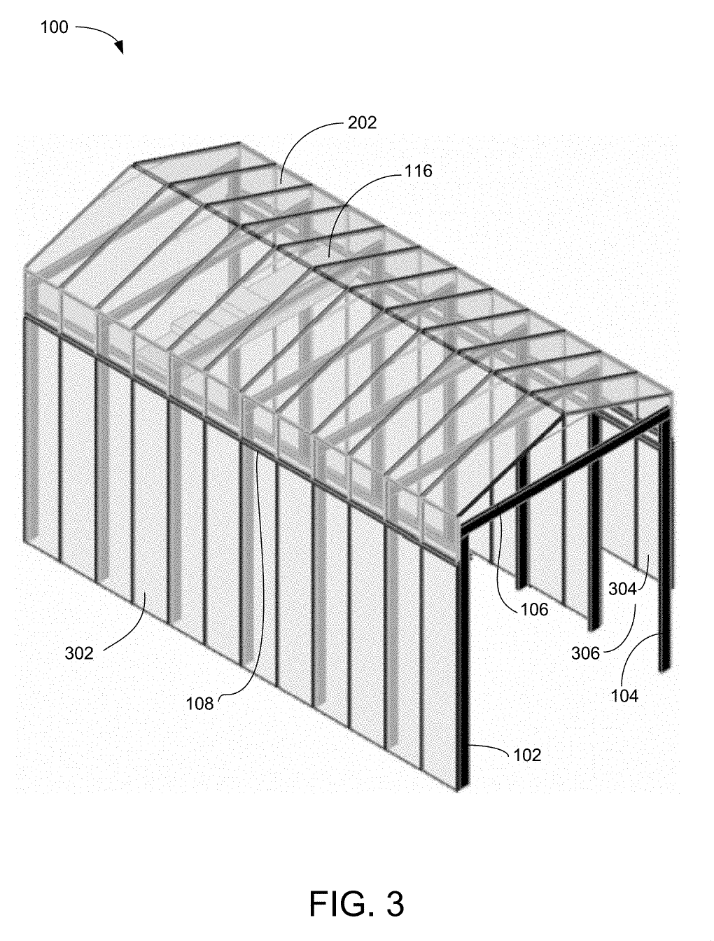

FIG. 3 is a top-front perspective view illustrating a first exemplary embodiment of a crane building 100 of FIG. 1 in a third phase of construction, according to a preferred embodiment of the present invention. Twelve four-panel folding sections 202 (one of twelve labeled) complete the roof of the crane building 100. Individual wall panels 302 (one of twenty-three labeled) on each side of crane building 100 are arranged in adjacent side-by-side array, as shown, and are similar to the wall panels in U.S. Pat. No. 9,222,250. Individual wall panels 302 enclose the space from the bottoms of the legs 102 and 104 (ground level) to the panel support beams 108 and 114. The individual wall panels 302 differ from the wall panels in U.S. Pat. No. 9,222,250 in that the top edges are adapted for attachment, preferably using releasable fasteners, to the panel support beams 108 and 114. Wall panels 302 are also attached to the concrete pad and to one leg 102 or 104 using releasable fasteners. A partial individual wall panel 304 does not extend to ground level to leave an access 306 for entry of smaller vehicles. In some embodiments, access 306 may have a roll-up door or similar type door.

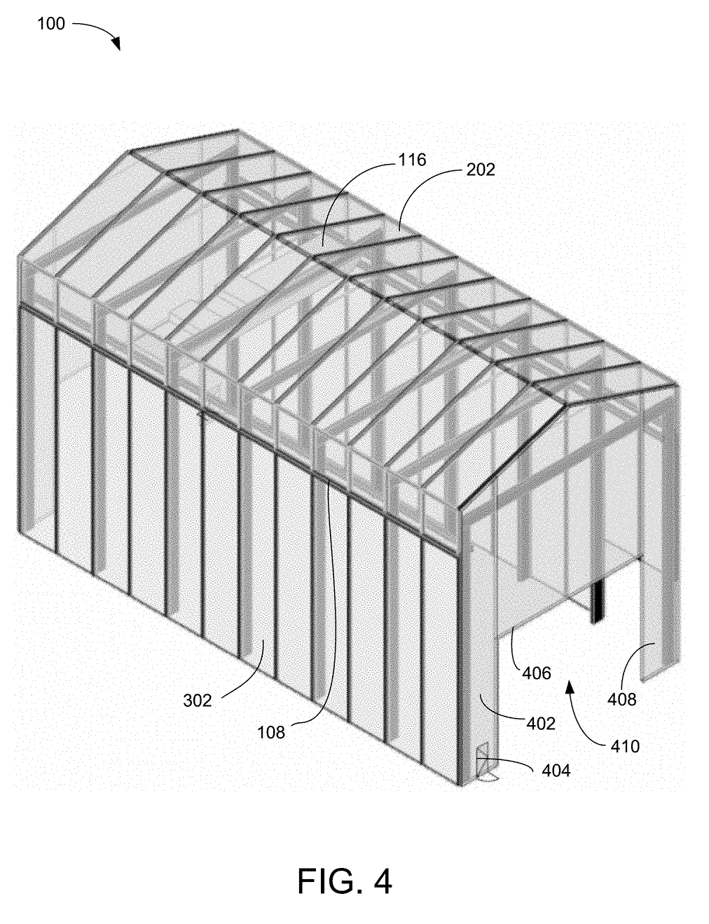

FIG. 4 is a top-front perspective view illustrating a first exemplary embodiment of a crane building 100 of FIG. 1 in a fourth phase of construction, according to a preferred embodiment of the present invention. End panels 402, 406 and 408 close off the end of the crane building 100 except for heavy equipment access 410. Personal access door 404 in end panel 402 gives some perspective as to size of this exemplary embodiment. In other embodiments, various end panel configurations, including complete closure, windows, and lighting may be used. In some embodiments, heavy equipment access 410 may have a releasable closure, such as a roll up door on end panel 406. In various embodiments, opposite ends of the crane building 100 may have different end panel configurations. End panels 402 and 408 are attached to legs 102 and 104, respectively, to crossbar 106, and to rafters 208 using releasable fasteners. End panel 406 is attached to crossbar 106, to column to end panels 402 and 408, and to rafters 208 using releasable fasteners.

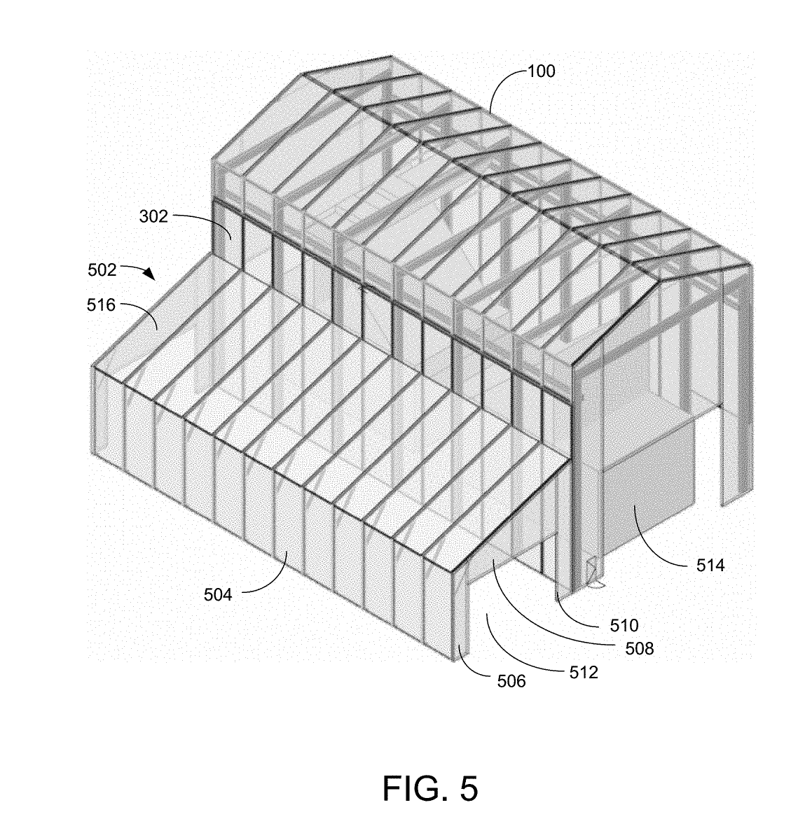

FIG. 5 is a top-front perspective view illustrating a first exemplary embodiment of a crane building of FIG. 1 in an optional fifth phase of construction, according to a preferred embodiment of the present invention. Crane building 100 is shown with heavy equipment 514 inside. Optional lean-to 502 is composed of two-panel folding sections 504 (one of twelve labeled) that are similar to halves of four panel folding sections of U.S. Pat. No. 9,222,250, but with adaptations at the top ends of the roof panels 516 for connecting, via releasable fasteners, to longer wall panels 302. Lean-to 502 has end panels 506, 508 and 510, releasably attached, forming equipment access 512. Other optional configurations include, without limitation, roll-up end wall doors, side wall doors, windows, skylights, and service corridors. As FIG. 5 suggests, there are many possible configurations and combinations of crane buildings 100 that may be made within the scope of the present disclosure. For non-limiting example, side-by side crane buildings with or without a longer wall panel 302 wall in between them are possible.

Although applicant has described applicant's preferred embodiments of this invention, it will be understood that the broadest scope of this invention includes such modifications as diverse shapes and sizes and materials. Such scope is limited only by the above specification and the claims below.

The advantages of the present invention include rapid construction times, lower labor costs, high headroom over the crane, expandability, customization potential, the ability to easily disassemble and relocate, and strength.

I claim:

1. A crane building comprising:
a. a plurality of moment frames arranged in linear spaced apart array to form a building frame having first and second sides defined by opposing spaced apart first and second pluralities of aligned vertical legs of said plurality of moment frames; and
b. first and second horizontal panel support beams attached to outside surfaces of said opposing first and second pluralities of vertical legs, respectively, and spaced below a top of said building frame, when installed.

2. The crane building of claim 1, comprising opposing first and second bridge crane rails attached to inside surfaces of said first and second pluralities of vertical legs, respectively, and spaced below said top of said building frame.

3. The crane building of claim 2, wherein said first and second horizontal panel support beams and first and second bridge crane rails are configured to be coplanar and parallel.

4. The crane building of claim 2, comprising a bridge crane mounted on said first and second bridge crane rails.

5. The crane building of claim 1, comprising a plurality of four-panel foldable building sections deployable to be releasably attached and supported in linear side-by-side adjacent array on said first and second horizontal panel support beams.

6. The crane building of claim 5, comprising said first and second opposed wall panels of each said four-panel foldable building section of said plurality of four-panel foldable building sections adapted to extend vertically from one of said first and second horizontal panel support beams to a location above said top of said building frame, when installed.

7. The crane building of claim 5, wherein each four-panel foldable building section of said plurality of four-panel foldable building sections comprises two opposed columns on said first and second opposed wall panels, wherein at least one column of said two opposed columns is adapted to be releasably attached to one leg of said opposed first and second pluralities of vertical legs of said plurality of moment frames, when installed.

8. The crane building of claim 1, comprising a plurality of individual side wall panels adapted to extend from a ground level to one of said first and second horizontal panel support beams, each wall panel of said plurality of individual wall panels further comprising two opposing columns, wherein at least one column of each said wall panel of said plurality of individual wall panels is adapted to be releasably attached to one leg of said opposed first and second pluralities of vertical legs of said plurality of moment frames, when installed.

9. The crane building of claim 8, comprising a lean-to further comprising a linear side-by-side adjacent array of a plurality of two-panel folding sections each releasably coupled to at least one said individual side wall panel of said plurality of individual side wall panels.

10. The crane building of claim 1, comprising at least one individual wall panel extending vertically downward from one of said first and second horizontal panel support beams to a level above ground level, when installed.

11. The crane building of claim 1, comprising at least one individual end wall panel further comprising at least one of:
a. a vertical extent from a ground level to an end rafter, when installed;
b. a vertical extent from at least one said end rafter to a level above ground level, when installed;
c. a personnel access door;
d. a window; and
e. a roll-up door.

12. A crane building comprising:
a. a plurality of moment frames arranged in linear spaced apart array to form a building frame having first and second sides defined by opposing spaced apart first and second pluralities of aligned vertical legs of said plurality of moment frames;
b. first and second horizontal panel support beams releasably attached to outside surfaces of said opposing first and second pluralities of vertical legs, respectively, and spaced below a top of said building frame; and
c. opposing spaced apart first and second bridge crane rails releasably attached to inside surfaces of said first and second pluralities of vertical legs, respectively, and spaced below said top of said building frame.

13. The crane building of claim 12, comprising a bridge crane mounted on said first and second bridge crane rails.

14. The crane building of claim 12, comprising:
a. a plurality of four-panel foldable building sections deployable to be supported in linear side-by-side adjacent array on, and releasably attached to, said first and second horizontal panel support beams;
b. said first and second opposed wall panels of each said four-panel foldable building section of said plurality of four-panel foldable building sections adapted to extend vertically from one of said first and second horizontal panel support beams to a location above said top of said building frame, when installed;
c. wherein each four-panel foldable building section of said plurality of four-panel foldable building sections comprises two opposed columns on said first and second opposed wall panels, wherein at least one column of said two opposed columns is adapted to be releasably attached to one leg of said opposed first and second pluralities of vertical legs of said plurality of moment frames, when installed.

15. The crane building of claim 1, comprising:
a. a plurality of individual side wall panels adapted to extend from a ground level to one of said first and second horizontal panel support beams, each wall panel of said plurality of individual wall panels further comprising two opposing columns, wherein at least one column of each said wall panel of said plurality of individual wall panels is adapted to be releasably attached to one leg of said opposed first and second pluralities of vertical legs of said plurality of moment frames, when installed; and
b. at least one individual wall panel extending vertically downward from one of said first and second horizontal panel support beams to a level above ground level, when installed.

16. The crane building of claim 8, comprising a lean-to further comprising a linear side-by-side adjacent array of a plurality of two-panel folding sections releasably coupled to at least one said individual side wall panel of said plurality of individual side wall panels.

17. The crane building of claim 1, comprising at least one individual end wall panel further comprising at least one of:
a. a vertical extent from a ground level to an end rafter, when installed;
b. a vertical extent from at least one said end rafter to a level above ground level, when installed;
c. a personnel access door;
d. a window; and
e. a roll-up door.

18. A crane building comprising:
a. a plurality of moment frames arranged in linear spaced apart array to form a building frame having first and second sides defined by opposing spaced apart first and second pluralities of vertical legs of said plurality of moment frames;
b. first and second horizontal panel support beams releasably attached to outside surfaces of said opposing first and second pluralities of vertical legs, respectively, and spaced below a top of said building frame, when installed;
c. opposing first and second bridge crane rails releasably attached to inside surfaces of said first and second pluralities of vertical legs, respectively, and spaced below said top of said building frame, when installed; and
d. wherein said first and second horizontal panel support beams and first and second bridge crane rails are configured to be coplanar and parallel.

19. The crane building of claim 18, comprising a bridge crane mounted on said first and second bridge crane rails.

20. The crane building of claim 18, comprising:
a. a plurality of four-panel foldable building sections deployable to be supported in linear side-by-side adjacent array on, and releasably attached to, said first and second horizontal panel support beams;
b. said first and second opposed wall panels of each said four-panel foldable building section of said plurality of four-panel foldable building sections adapted to extend vertically from one of said first and second horizontal panel support beams to a location above said top of said building frame, when installed;
c. wherein each four-panel foldable building section of said plurality of four-panel foldable building sections comprises two opposed columns on each of said first and second opposed wall panels, wherein at least one column of said two opposed columns is adapted to be releasably attached to one leg of said opposed first and second pluralities of vertical legs of said plurality of moment frames, when installed.
d. a plurality of individual side wall panels adapted to extend from a ground level to one of said first and second horizontal panel support beams, each wall panel of said plurality of individual wall panels further comprising two opposing columns, wherein at least one column of each said wall panel of said plurality of individual wall panels is adapted to be releasably attached to one leg of said opposed first and second pluralities of vertical legs of said plurality of moment frames, when installed;
e. at least one individual wall panel extending vertically downward from one of said first and second horizontal panel support beams to a level above ground level, when installed; and
f. at least one individual end wall panel further comprising at least one of:
i. a vertical extent from a ground level to an end rafter, when installed;
ii. a vertical extent from at least one said end rafter to a level above ground level, when installed;
iii. a personnel access door;
iv. a window; and
v. a roll-up door.
